(19) United States
(12) Patent Application Publication
(10) Pub. No.: US 2023/0222417 A1
(43) Pub. Date: Jul. 13, 2023

(54) AUTOMATED ELECTRONIC DATA INTERCHANGE APPLICATION

(71) Applicants: Jawad Khan, Cranbury, NJ (US); Ahmed Samnan Raza, Cranbury, NJ (US)

(72) Inventors: Jawad Khan, Cranbury, NJ (US); Ahmed Samnan Raza, Cranbury, NJ (US)

(21) Appl. No.: 18/094,814

(22) Filed: Jan. 9, 2023

Related U.S. Application Data
(60) Provisional application No. 63/361,573, filed on Jan. 7, 2022.

(51) Int. Cl. G06Q 10/0631

(52) U.S. Cl. CPC G06Q 10/06316

(57) ABSTRACT

A software system comprising of many-to-many input data sources, data, storage and processing medium, executable software instructions that, when executed by the application, enable the software to receive, standardize heterogenous data, and perform business translation logic. This data translation and standardization process generates a standard object hierarchy, organizing outcome in common translatable objects corresponding to active graphical user interface elements. The application enables interface of heterogenous datasets with a hierarchical representation of the data as active GUI elements, creating an interfacing object for each of the active GUI elements represented in the hierarchical representation; and organizing the objects into the standard hierarchy based on relationships among active GUI elements. In final step, the software executes the updating of data and transmission, using software program to transform, update, standardize, and re-transmit to receiving systems on a schedule-based approach, in rapid, recurring and automated scheduled format between business entities.

### CROSS-REFERENCE TO RELATED APPLICATIONS

This application claims the benefit of priority of Provisional Patent Application US 63/361,573, titled “AUTOMATED ELECTRONIC DATA INTERCHANGE APPLICATION,” Jan. 7, 2022, the contents of which are incorporated by reference in their entirety.

### BACKGROUND

### TECHNICAL FIELD

The present disclosure relates, in general, to electronic data interchange software, particularly, but without limitation, to an automated electronic data interchange to reduce repetitive tasks in data file interchanges, via software automation.

Electronic data interchange software methods are known in the art.

US 2011/0040703 discloses a system, method and program product to estimate cost of integrating and utilizing heterogeneous data sources.

US 2006/0259442 discloses a system, method and program product to estimate cost of integrating and utilizing heterogeneous data sources.

US 2005/0066263 discloses a System and Method For Generating Data Validation Rules.

The art discloses a software system to automate (repetitive) communications, updates, tracking of heterogeneous data inputs and systems.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A software application and its design (embedded digital processing logic) is disclosed, that relates to data manipulation, updating, and sharing, within the Supply Chain Automation sectors, and business critical Electronic Data Interchanges (EDI) processes, specifically relating to data integration, data standardization, manipulation and updates, data entity-tracking, and the automating of digital data sharing methods and processes.

Methods and logic for integrating, interfacing, and manipulating/updating data between many-to-many source systems are driven by a graphical user interface (GUI) are newly invented and disclosed.

In an aspect, the application logic and methods generate an automated model, structured and repetitive workflow, and process interfacing plus sharing information and data; between one-to-many business entities.

The contained data, and its metadata components have logical rules and validation (digital handshakes) in this disclosure allow for automated setup and processing as part of the system.

The systemic design (process) operates in an automatic (automated) schedule, on a daily, weekly, or monthly, with formal process tracking, status-reporting, and legally verifiable method for end-user corporations’ data-communications.

Furthermore, the result of this standardization (of common foundation structures), rule-sets, and logical methods increases efficiency and quality of data, required business sharing, including elimination of (prior; manually derived) transmission errors, manual oversight, manual intervention, and additional work to remediate.

In an aspect of the disclosure, a system for automated electronic business data translation is disclosed. The system is configured to include: retrieving one or more heterogeneous business data files from an input business data source for ingestion into an electronic business load engine; translating the one or more heterogeneous data files into one or more standardized business data files; processing the one or more standardized business data files for validation; processing, after the validation of the one or more standardized business data files, the one or more standardized business data files for output to a business data consumer destination; and to one or more destination business systems within an organization to store or process the one or more standardized business data files.

In an aspect, a Multi-role Intelligent Dynamic Orchestrator (MIDO) for distributed synchronous and asynchronous processing of one or more heterogeneous data file is disclosed. The MIDO includes Universal Electronic Document Processing language (UDPDL) database configured to store process flow definitions and/or process flow rules for distributed synchronous and asynchronous processing of the one or more heterogeneous data files; a process clock configured to list overdue jobs in the UDPDL database and coordinate the distributed synchronous and asynchronous processing of the one or more heterogeneous data files; a cloud processor configured to determine a step in a process flow in the distributed synchronous and asynchronous processing of the one or more heterogeneous data files and determine a job in a cloud process available in one or more cloud regions in communication with the MIDO to execute the determined step; and a job execution engine configured to select an instance of a job step function from a library of execution functions and select a physical cloud node from the one or more cloud regions for execution of the determined job in the cloud process.

In an aspect, a GUI interface for generating UDPDL process flows for conversion of electronic business data is disclosed. The GUI includes a load graphical interface object configured to allow a user to select load process settings for the UDPDL process flows; a validate graphical interface object configured to allow a user to select validation process settings for the UDPDL process flows; a mapping graphical interface object configured to allow a user to select mapping and business rule process settings for the UDPDL process flows; and an import graphical interface object configured to allow a user to select import process settings for the UDPDL process flows.

The foregoing summary is illustrative only and is not intended to be in any way limiting. In addition to the illustrative aspects, aspects, and features described above, further aspects, aspects, and features will become apparent by reference to the drawings and the following detailed description

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 illustrates an exemplary of a cloud-based network that may implement parts of an automated business data exchange, according to an aspect of the disclosure.

FIG. 2 illustrates an exemplary block diagram of a system for an automated business data interchange, according to an aspect of the disclosure;

FIG. 3 illustrates an exemplary block diagram of a Multi-role Intelligent Dynamic Orchestrator, according to an aspect of the disclosure.

FIG. 4 illustrates a Universal Electronic Document Processing Flow Definition Language key structure, according to an aspect of the disclosure.

FIG. 5 illustrates a flowchart for acts taken in an exemplary method for an inbound data flow for the automated business data exchange, according to an aspect of the disclosure.

FIG. 6 illustrates a flowchart for acts taken in an exemplary method for an outbound data flow for the automated business data exchange, according to an aspect of the disclosure.

FIG. 7 illustrates an exemplary graphical user interface for an automated business data exchange, according to an aspect of the disclosure.

FIG. 8 illustrates an exemplary diagram of a Load interface menu, according to an aspect of the disclosure.

FIG. 9 illustrates an exemplary diagram of a Validate interface menu, according to an aspect of the disclosure.

FIG. 10 illustrates an exemplary diagram of a Mapping interface menu, according to an aspect of the disclosure.

FIG. 11 illustrates an exemplary diagram of an Import interface menu, according to an aspect of the disclosure.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Bracketed text and blocks with dashed borders (e.g., large dashes, small dashes, dot-dash, dots) are used herein to illustrate optional operations that add additional features to aspects of the invention. However, such notation should not be taken to mean that these are the only options or optional operations, and/or that blocks with solid borders are not optional in certain aspects of the invention.

An electronic device or computing device (e.g., an end station, a network device) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals - such as carrier waves, infrared signals). In addition, such electronic devices includes hardware such as a set of one or more processors coupled to one or more other components, such as one or more non-transitory machine-readable media (to store code and/or data), user input/output devices (e.g., a keyboard, a touchscreen, and/or a display), and network connections (to transmit code and/or data using propagating signals). The coupling of the set of processors and other components is typically through one or more busses and bridges (also termed as bus controllers). Thus, a non-transitory machine-readable medium of a given electronic device typically stores instructions for execution on one or more processors of that electronic device. One or more parts of an aspect of the invention may be implemented using different combinations of software, firmware, and/or hardware.

As used herein, a network device (e.g., a router, switch, bridge) is a piece of networking equipment, including hardware and software, which communicatively interconnects other equipment on the network (e.g., other network devices, end stations). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, tablets, palm tops, mobile phones, smartphones, multimedia phones, Voice Over Internet Protocol (VOIP) phones, user equipment, terminals, portable media players, GPS units, gaming systems, set-top boxes) are computing devices, typically operated by users, that access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer-to-peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network devices, which are coupled (e.g., through one or more core network devices) to other edge network devices, which are coupled to other end stations (e.g., server end stations).

Cloud computing is generally defined as a computing capability that provides an abstraction between the computing resource and its underlying physical architecture (e.g., server computing systems, storage devices and systems, networks), enabling convenient, on-demand network access to a shared pool of configurable computing resources that can be rapidly provisioned and released with minimal management effort or service provider interaction. Resources provided by cloud computing providers may be said to be “in a cloud.” Cloud-resident elements may include, without limitation, storage devices, servers, databases, computing environments (including virtual machines and desktops), networks, and applications. In some settings, Internet-based applications, which are sometimes provided under a “software-as-a-service” (SAAS) model, may be referred to as cloud-based resources.

Cloud computing operators, or cloud operators, typically offer cloud services to many tenants. A tenant, for the purposes of this disclosure, is best understood as a person or organization that has requested cloud-based resources from the cloud operator. In some aspects, the tenant may request and manage cloud-based resources from a cloud provider using a subscriber end station or computing device.

According to some aspects, the presently disclosed system and/or method for integrating, interfacing, and manipulating/updating data between systems are driven by a graphical user interface (GUI) are disclosed.

In an aspect, the application logic and methods generate an automated model, structured workflow, and process interfacing, between one-to-many business entities in Universal Electronic Document Processing flow Definition Language (“UDPDL”).

In an aspect, the contained data, and its metadata components have logical rules and validation (digital handshakes) in the disclosed automated electronic business data interchange, allowing for automated setup and processing as part of the system.

In an aspect, the system will digitally automate communications between heterogenous applications or systems, without human interaction.

In an aspect, the application workflow (process) is automated, with end-to-end embedded logic, leveraging heuristics, and is configurable to automatically run and process on a by-minute, hourly, daily, weekly, and monthly (scheduled) basis.

In an aspect, the disclosed automated electronic business data interchange uses a three-step approach to process any transaction and translate it to any customizable format.

More particularly, the disclosed automated electronic business data interchange provides an electronic document processing flow system with JavaScript Object Notation (“JSON”) schema specification for a novel Universal Electronic Document Processing flow Definition Language (“UDPDL”) and a GUI for instantiating complex and multi-step conformed document process flows (e.g., a “digital recipe”) based on (multiple end-user’s) input, and the integrated runtime logic and execution engine for UDPDL Process Flows with a Multi-role Intelligent Dynamic Orchestrator (“MIDO”) for distributed synchronous and asynchronous processing of the instantiated document processing flows.

In an aspect, a Multi-role Intelligent Dynamic Orchestrator for distributed synchronous and asynchronous processing is disclosed. The MIDO ingests inbound and outbound document processing flows with adaptive healing based on environmental variables.

In an aspect, the MIDO provides asynchronous, distributed processing of the flows in a highly parallel performance-oriented environment. The MIDO may provide dynamic allocation and scaling of elastic compute resources for document processing flows based on situational intelligence (trend data of processing steps, data volumes, current response times and cost). In an aspect, the MIDO provides adaptive healing of resources (such as health, performance, reliability, etc.) across cloud regions or multi-cloud systems.

The following briefly describes the aspects of the disclosure to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

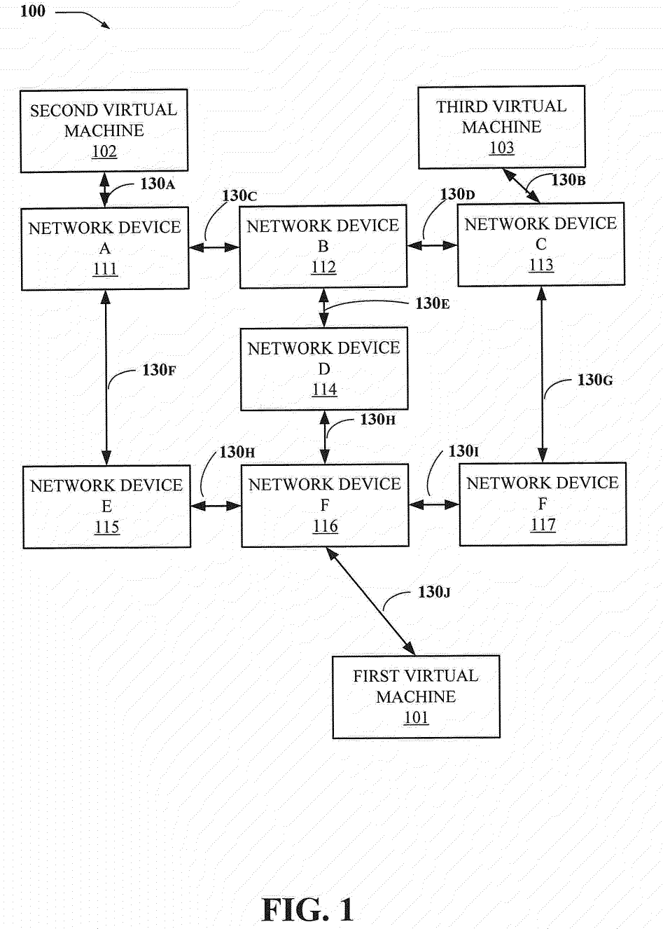

FIG. 1 illustrates an exemplary of a cloud-based network that may implement parts of an automated business data exchange, according to an aspect of the disclosure. FIG. 1 includes a multi-tenant cloud network 100 including three virtual machines (“VMs”) (102, 103, 104) executing on a set of one or more host computing devices (not illustrated), to host or perform parts or all of one or more components of the disclosed automated business data exchange. For purposes of this disclosure, the VMs may each execute on a different host computing device, or some or all of the VMs may execute on a shared host computing device. The VMs 102, 103, 104 of FIG. 1 are connected using a plurality of communications links 130A-130K and network devices ‘A’-‘G’ (111, 112, 113, 114, 115, 115, 116, 117). In some aspects, each network device 111-117 is a separate physical device and each communications link 130A-130J is a separate physical communications link (e.g., a network cable such as Category 5 (Cat5) cable, twisted pair cable, coaxial cable, copper wire cable, other electrical cable, optical cable, power line, etc.), a wireless connection (802.11xx, cellular communications/data networks, WiMAX or other wireless data network technology known to one of skill in the art) but in other aspects, one or more of the network devices 111-117 and/or communications links 130A-130J are virtualized (e.g. virtual network devices, virtual communications links).

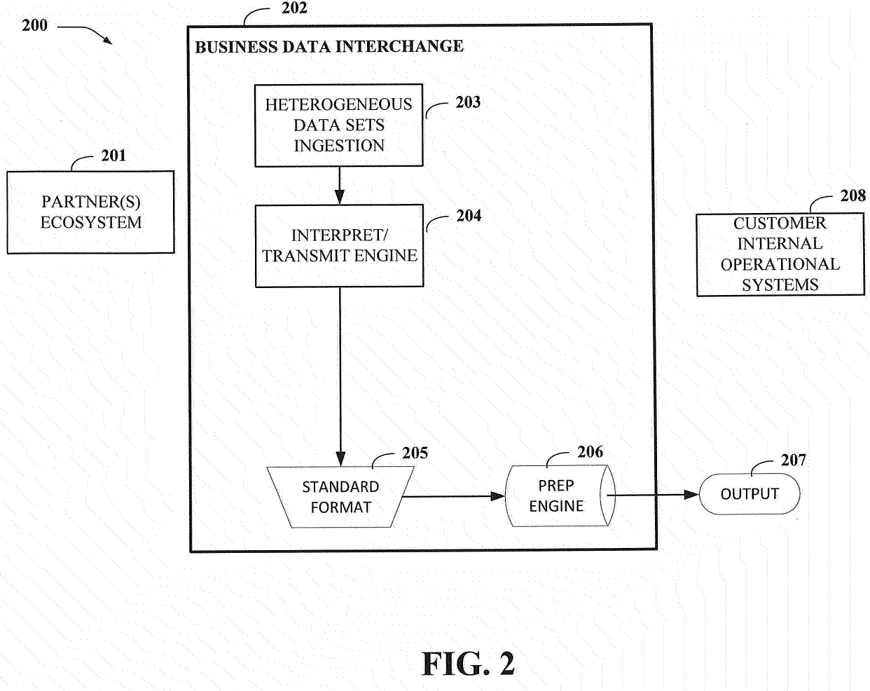

FIG. 2 illustrates an exemplary block diagram of a system for an automated business data interchange, according to an aspect of the disclosure. A partner ecosystem 401 may be in electronic communication with a business data exchange 202. The partner ecosystem 201 may include, for example but not limiting, Factories, Customers, Distributors, Fraud Solutions, Loyalty Solutions, Third Party (3PL) Services, Payment Gateways, Portal Services, Warehouses, Wholesalers, Suppliers, Retailers, etc. One or more partners of the partner ecosystem 201 may communicate and transmit business data to the business data interchange 202. The business data may be in the form of one or more heterogeneous data files, which, in an aspect, may be EDI, XML, JSON, EDIFACT, , , X12 or like formats.

The heterogeneous data sets ingestion engine 203 may ingest and retrieve the one or more heterogeneous business data files from an input business data source for ingestion into an electronic business load engine, which may be in the form of a database or store in the heterogeneous data sets ingestion engine 203.

An interpret/translate engine 204 may be in communication with the heterogeneous data sets ingestion engine 203. The interpret/translate engine 204 may computationally translate, interpret, update, combine, and ultimately digitally transmit data to other systems in an automated and scheduled fashion. In an aspect, the interpret/translate engine 204 includes a Multi-role Intelligent Dynamic Orchestrator (“MIDO”) for distributed synchronous and asynchronous processing of the instantiated document processing flows. The MIDO ingests inbound and outbound document processing flows with adaptive healing based on environmental variables. In an aspect, the MIDO provides asynchronous, distributed processing of the flows in a highly parallel performance-oriented environment. The MIDO may provide dynamic allocation and scaling of elastic compute resources for document processing flows based on situational intelligence (trend data of processing steps, data volumes, current response times and cost). In an aspect, the MIDO provides heuristics monitoring and adaptive healing of resources (such as health, performance, reliability, etc.) across cloud regions. The one or more standardized business data files are then sent to a preparation engine 206. The preparation engine 206 may serve to validate the one or more standardized business data files and prepare the data files for transmission to other systems within the organization.

Once validated and prepared, the one or more standardized business data files are then transmitted to an output store 207 for access by customer internal operational systems 408. Examples of customer internal operational systems 408 include, but are not limited to, MS Dynamics, SAP, Oracle NetSuite, Salesforce, Magento, Shopify, Amazon, BigCommerce, Ebay, FedEx, UPS, etc.

Most supply chain industry businesses use multiple software Enterprise resource planning systems, supply chain automation, and databases; such as vendors: Microsoft Dynamics Enterprise resource planning (ERP), Salesforce Enterprise resource planning (ERP), SAP Enterprise resource planning (ERP), Oracle SCM, and other business Commerce solutions; to store customer information and data, business sales information, and metadata information about each vendor and partner in their business ecosystem.

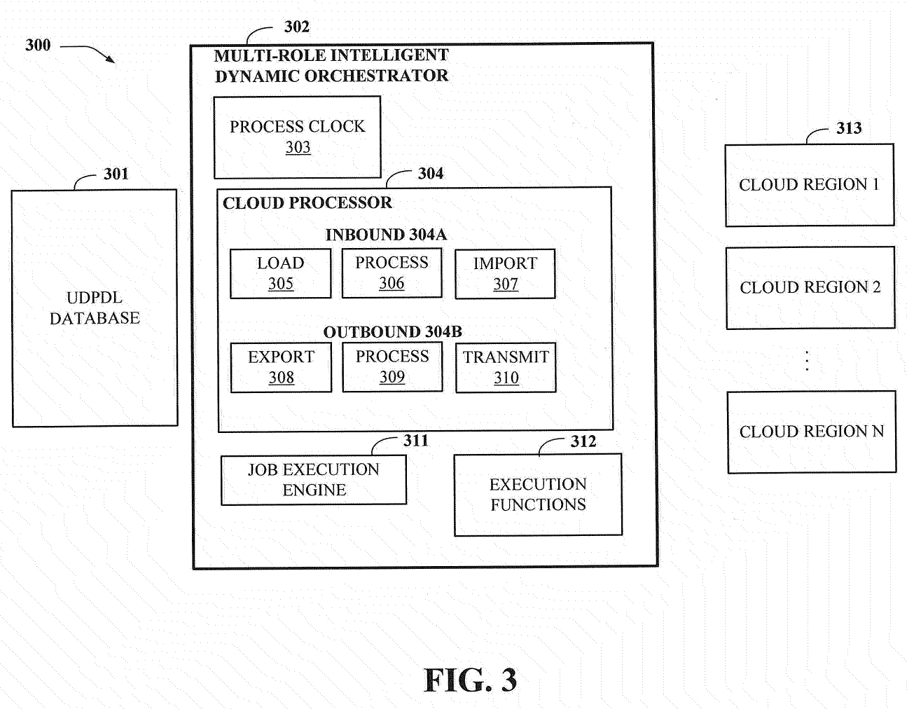

FIG. 3 illustrates a block diagram of an exemplary interpret/translate engine 300 using a MIDO 302 as described in FIG. 2. The interpret/translate engine 300 includes a UDPDL Database 301. The UDPDL Database 301 contains a database of templates and containers for the disclosed UDPDL. In an aspect, all process flow definitions in UDPDL are stored in the UDPDL Database 301.The UDPDL Database 301 is pre-populated with descriptions, data fields, scripts and other templates, containers or code that may be necessary for the automated data exchange to import and translate the one or more heterogeneous data sets into a format for use in internal consumption or for external customers. The UDPDL Database 301 receives data from the partner ecosystem 201 (illustrated and described in FIG. 2).

In an aspect, the interpret/translate engine 300 includes a MIDO 302. In an aspect, the UDPDL Database 301 may be included as a component of the MIDO 302. The MIDO 302 includes a Process Clock 303, whose function is to list all overdue jobs in the UDPDL Database 301. For example, the overdue jobs may include jobs that against the Process Clock 303 has an instance that needs to be run based on a UDPDL schedule definition.

In an aspect, the interpret/translate engine 300 includes a Cloud Processor 304 to run jobs based on UDPDL specifications. The Cloud Processor 304 is configured to understand which step a job is at and identify the WebJobs in a cloud process that needs to be run. The Cloud Processor 304 is configured to run an Inbound Process Flow 304A and an Outbound Process Flow 304B.

In the Inbound Process Flow 204A, three step jobs are available to the Cloud Processor 304 - a Load Step Job 305, a Process Step Job 306 and an Import Step Job 307. In the Outbound Process Flow 204B, three step jobs are available to the Cloud Processor 304 -an Export Step Job 308, a Process Step Job 309 and an Import Step Job 310.

In the Inbound Process Flow 204A, during the Load Step Job 305, the system reads the inbound one or more heterogeneous business data files received from multiple partners in many different formats, including, for example, but without limitation EDI, and translates it into to an optimized standardized business data format.

In an aspect, the MIDO 302 ingests inbound and outbound document processing flows with adaptive healing based on environmental variables. In an aspect, the MIDO 302 provides asynchronous, distributed processing of the flows in a highly parallel performance-oriented environment. The MIDO 302 may provide dynamic allocation and scaling of elastic compute resources for document processing flows based on situational intelligence (trend data of processing steps, data volumes, current response times and cost). In an aspect, the MIDO 302 provides heuristics monitoring and adaptive healing of resources (such as health, performance, reliability, etc.) across cloud regions or multi-cloud systems.

During the Process Step Job 306, the MIDO 302 translates the one or more heterogeneous data files into the one or more standardized business data files. The MIDO 302 may generate a standard object hierarchy and organize the one or more standardized business data files into common translatable objects corresponding to active GUI elements. In a further aspect, the MIDO 302 may generate an interface of the one or more heterogeneous data files, where the interface is configured to display a hierarchical representation of the one or more heterogeneous data files as one or more active GUI elements, create an interfacing object for each of the one or more active GUI elements represented in the hierarchical representation, and organize the interfacing object for each of the one or more active GUI elements into the standard object hierarchy based on relationships among the one or more active GUI elements.

During the Import Step Job 307, the MIDO 302 stores the translated one or more heterogeneous data sets in the one or more standardized business datafiles in a temporary or permanent storage or cache.

Similarly, for an Outbound Process Flow 204B, the Export Process Step Job 308 retrieves the one or more standardized business data files in the temporary or permanent storage or cache. During the Process Step Job 309, the MIDO 302 processes the one or more standardized business data files for consumption by a customer internal operational systems 208 (as shown and described in FIG. 2). During the Transmit Step Job, the one or more standardized business data files are transmitted to an appropriate end user customer or client.

In an aspect, the Cloud Processor 304 invokes a cloud job to make use of cloud computing functionality available in Cloud Regions 313 (which may include one ore more cloud regions or cloud computing systems available to the MIDO 302. The cloud job may be one of the steps executed by one or more of the components of the Inbound Process Flow 304A and/or the Outbound Process Flow 304B. In an aspect, the MIDO calls a Job Execution Engine 311 to identify Execution Functions 312 associated with the job for processing in the disclosed automated data exchange from a library of execution functions. In an aspect, examples of Execution Functions 312 include, but are not limited to, mapping, business rules, validations (EDI/Non-EDI), each supported ERP functions, transport functions (FTP, SFTP, AS2 etc.) and other execution functions that may be required to implement the automated electronic business data interchange.

In an aspect, the Job Execution Engine 311, which may be configured to be heuristic engine, to collect information about processing availability and capabilities of Cloud Regions 313 to support the Execution Functions 312. Examples of heuristic information may include, but are not limited to, information about the Execution Functions 312 and Cloud Regions 313, such as a maximum number of threads for each function, run times for each thread, available cloud nodes, node health (available/ not available) and other heuristic information that the Job Execution Engine 311 may retrieve to select a resource for a cloud job.

In an aspect, based on a best available Cloud Region 313, the Job Execution Engine 311 selects an instance of a function from the Execution Functions 312 and a physical cloud node from the Cloud Regions 313 for execution by the Cloud Regions 313. The selected function is executed by one of the Cloud Regions 313 and an output is generated from the Cloud Regions 313.

In an aspect, the UDPDL Database 301 is updated with next steps. In an aspect, the Job Execution Engine 311 is updated with statistics and/or heuristic information collected from the Cloud Regions 313 after processing of the cloud job. The process flow described in FIG. 3 may be performed iteratively.

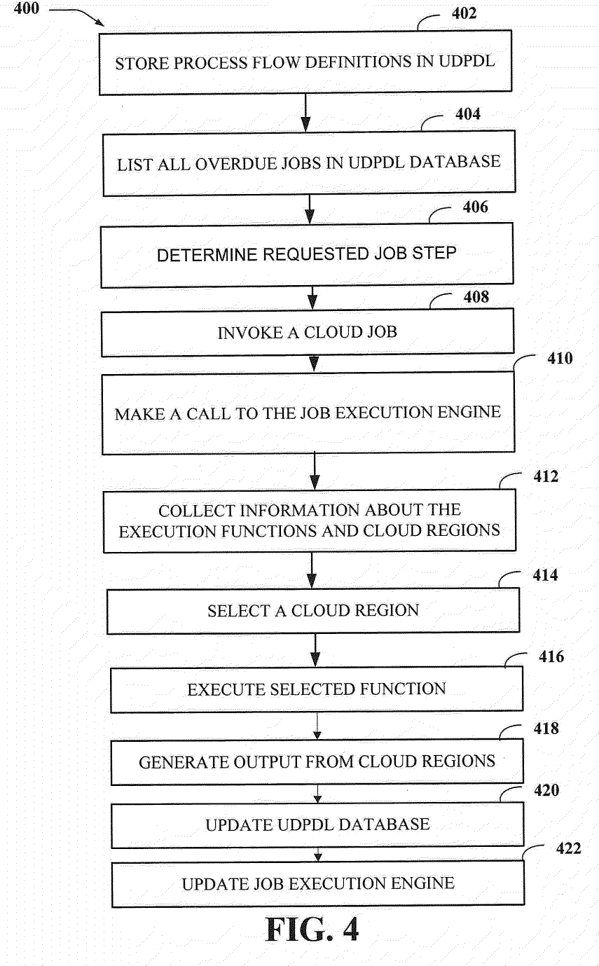

FIG. 4 illustrates a flowchart 400 for acts taken in an exemplary method for a MIDO 302 to process business information data with an automated business information interchange. Control begins at act 402.

In an aspect, at act 402, all process flow definitions in UDPDL are stored. In an aspect, the process flow definitions are stored in the UDPDL Database 301.

At act 404, the MIDO 302 lists all overdue jobs in UDPDL Database 301, such as, for example, but not limiting, jobs that against the Process Clock 303 has a instance that needs run based on UDPDL definitions and specifications.

At act 406, the MIDO 302 understands and determines which step the requested job is at and identifies the WebJobs in the cloud process that needs to be run.

At act 408, the MIDO 302 invokes a cloud job to execute any of the step jobs to be processed by the MIDO 302, such as step jobs for an Inbound Process Flow 304A (a Load Step Job 305, a Process Step Job 306 and/or an Import Step Job 307) or an Outbound Process Flow 304B (an Export Job Step 308, a Process Step Job 309 and/or a Transmit Step Job 310).

At act 410, the MIDO 302 makes a call to the Job Execution Engine 311 to identify one of Execution Functions 312 associated with the job.

At act 412, the Job Execution Engine 311 collects information about the Execution Functions 312 and/or information about one or more cloud regions 313 which may execute the job step.

At act 414, the Job Execution Engine 311 selects a one or more cloud regions 313 based on best available cloud computing resources and selects an instance of a function from the Execution Functions 312 and a physical cloud node from the Cloud Regions 313 for execution.

At act 416, the selected function from the Execution Functions 312 is executed at the selected one or more Cloud Regions 313.

At act 418, output from the one or more Cloud Regions 313 is generated.

At act 420, the UDPDL Database 301 is updated with next job steps for processing by the MIDO 302.

At act 422, in an aspect, the Job Execution Engine 311 is updated with statistics and/or heuristic information about the Cloud Regions 313, which may improve the performance of the MIDO 302 in future executions.

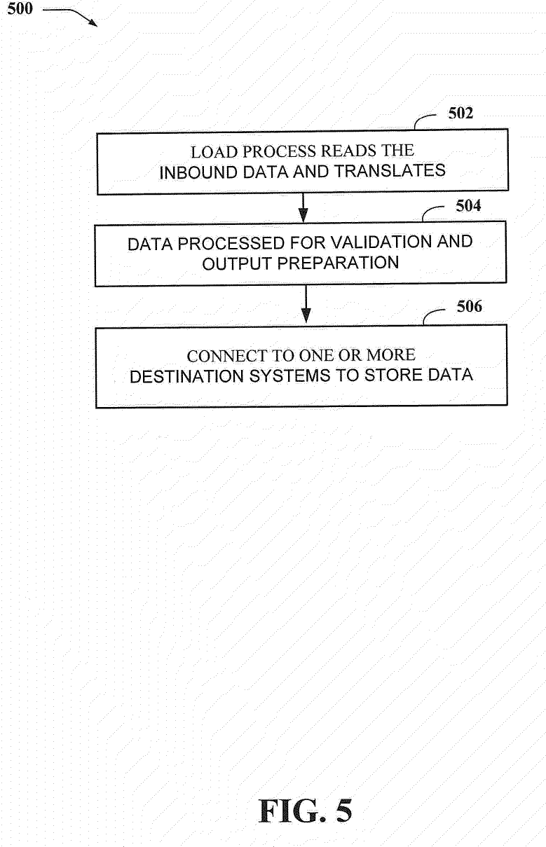

FIG. 5 illustrates a flowchart 500 for acts taken in an exemplary method for processing an inbound data flow using the automated electronic business interchange. FIG. 5 is explained in conjunction with FIG. 1 to FIG. 4. The control starts at act 602.

At act 502, the system, during a load process, reads the inbound one or more heterogeneous business data files received from multiple partners in many different formats, including, for example but not limiting, EDI, and translates it into to an optimized standardized business data format.

In an aspect, the system includes a Multi-role Intelligent Dynamic Orchestrator (“MIDO”) 302 for distributed synchronous and asynchronous processing of the instantiated document processing flows. The MIDO 302 ingests inbound and outbound document processing flows with adaptive healing based on environmental variables. In an aspect, the MIDO 302 provides asynchronous, distributed processing of the flows in a highly parallel performance-oriented environment. The MIDO 302 may provide dynamic allocation and scaling of elastic compute resources for document processing flows based on situational intelligence (trend data of processing steps, data volumes, current response times and cost). In an aspect, the MIDO 302 provides heuristics monitoring and adaptive healing of resources (such as health, performance, reliability, etc.) across cloud regions or multi-cloud systems.

In an aspect, the system’s translating the one or more heterogeneous data files into the one or more standardized business data files comprises generating a standard object hierarchy; and organizing the one or more standardized business data files into common translatable objects corresponding to active GUI elements. In a further aspect, the system may generate an interface of the one or more heterogeneous data files, where the interface is configured to display a hierarchical representation of the one or more heterogeneous data files as one or more active GUI elements; create an interfacing object for each of the one or more active GUI elements represented in the hierarchical representation; and organize the interfacing object for each of the one or more active GUI elements into the standard object hierarchy based on relationships among the one or more active GUI elements.

At act 504, the system validates the one or more standardized business data files. The validation may include determining if the one or more standardized business data files are in an EDI format or not. In an aspect, if the one or more standardized business data files are not in an EDI format, the system may throw an exception and indicate a processing error.

At act 506, the system connects to one or more destination business systems within an organization to store the one or more standardized business data files.

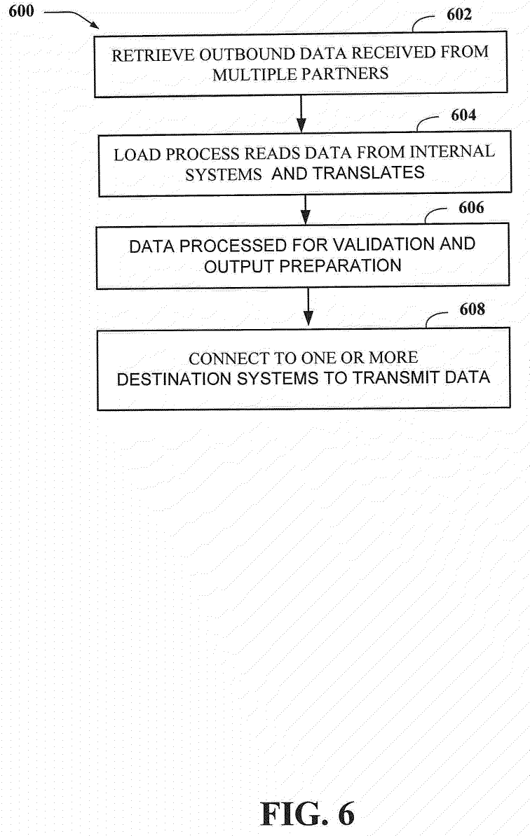

FIG. 6 illustrates a flowchart 600 for acts taken in an exemplary method for processing an outbound data flow using the automated electronic business interchange. FIG. 6 is explained in conjunction with FIG. 1 to FIG. 5. The control starts at act 602.

At act 602, the system retrieves outbound data that would be received from multiple systems within an organization to send out to partners.

At act 604, a load process reads data from internal systems and translates the data into to an optimized standardized business data format.

In an aspect, the system includes a Multi-role Intelligent Dynamic Orchestrator (“MIDO”) 302 for distributed synchronous and asynchronous processing of the instantiated document processing flows. The MIDO 302 ingests inbound and outbound document processing flows with adaptive healing based on environmental variables. In an aspect, the MIDO provides asynchronous, distributed processing of the flows in a highly parallel performance-oriented environment. The MIDO may provide dynamic allocation and scaling of elastic compute resources for document processing flows based on situational intelligence (trend data of processing steps, data volumes, current response times and cost). In an aspect, the MIDO provides adaptive healing of resources (such as health, performance, reliability, etc.) across cloud regions or multi-cloud systems.

At act 606, the system processes the one or more standardized business data files to be divided into multiple steps for data validation and output preparation for various destination partners as a required format for a particular destinations partner. The validation may include determining if the one or more standardized business data files are in an EDI format or not. In an aspect, if the one or more standardized business data files are not in an EDI format, the system may throw an exception and indicate a processing error.

At act 608, the system collects all the formatted one or more standardized business data files during the step 606 above, connects to destination partners, and transmits the formatted one or more standardized business data files to the partner.

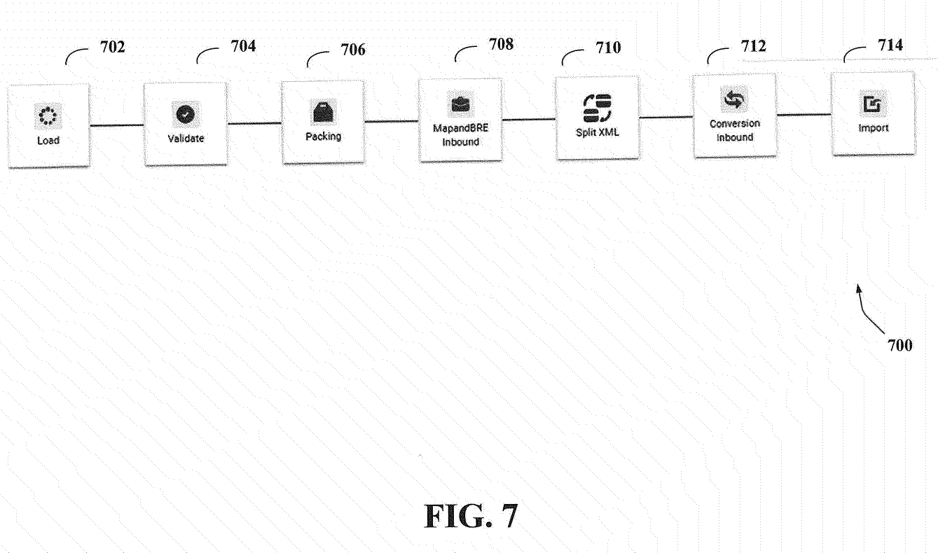

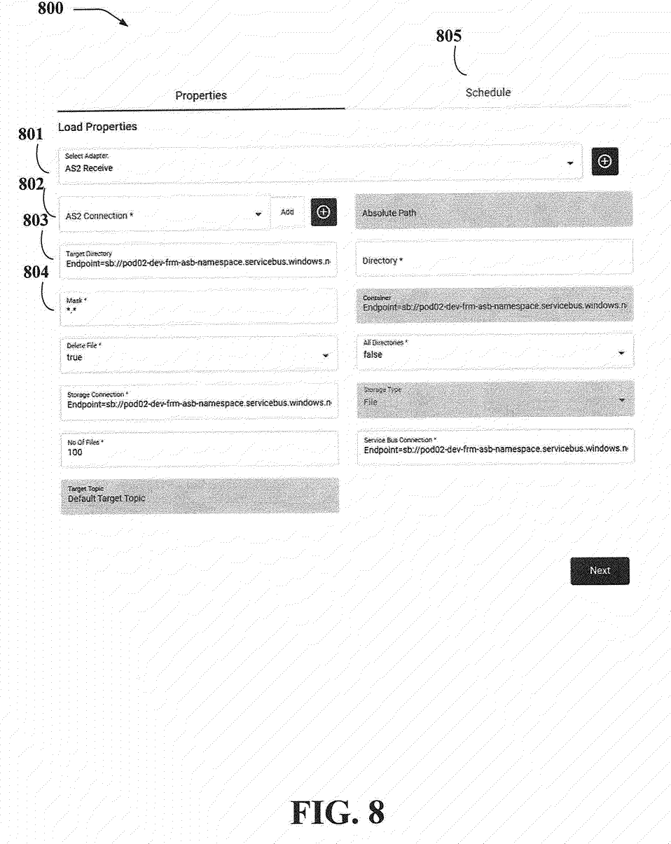

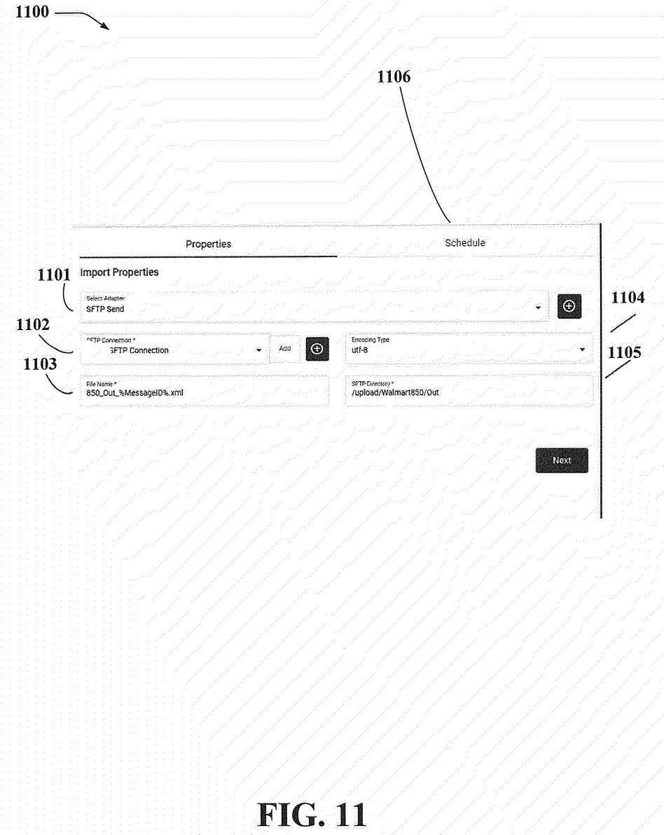

FIG. 7 illustrates an exemplary graphical user interface (“GUI”) 700 for an automated business data exchange, according to an aspect of the disclosure. The GUI 700 includes one or more graphical interface objects (702-714) that allow a user of the disclosed automatic business data interchange system to configure a MIDO to process electronic business data. The GUI 700 may be used to instantiate a “digital recipe” for conducting document processing workflows. FIG. 8 - FIG. 11 illustrate example menus provided to a user through the GUI 700 through the graphical interface elements (702-714). It is understood that the illustrated GUI 700, graphical interface elements (702-714) and menus illustrated herein are exemplary and other objects or presentations may be available for use with the GUI 700 and graphical interface elements (702-714) without changing the scope or breadth of this disclosure.

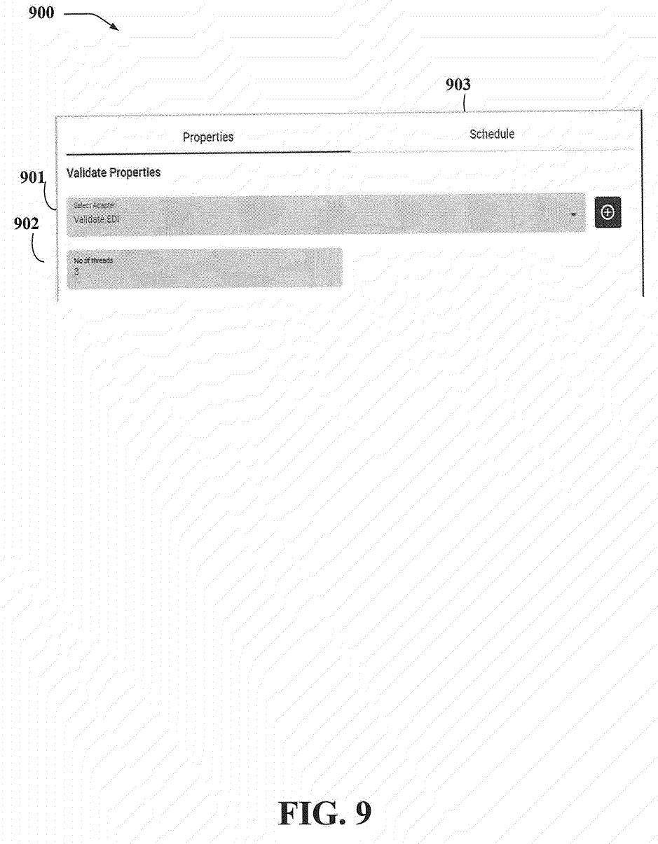

The GUI 700 may include a Load graphical interface object 702 that is configured to provide a menu for a user to input desired Load Function information (illustrated in FIG. 8). In an aspect, the GUI 700 may include a Validate graphical interface object 704 to allow a user to select options from a Validate menu (illustrated in FIG. 9). In an aspect, the Validate graphical interface object 704 allows a user to specify validation rules for the process flow for the electronic business data, such as EDI/non-EDI validation. Other validation rules are possible.

In an aspect, the GUI 700 may include a Packing graphical interface object 706 that allows a user to specify conversion of the electronic business data into a different file format and/or prepare the electronic business data for subsequent processing.

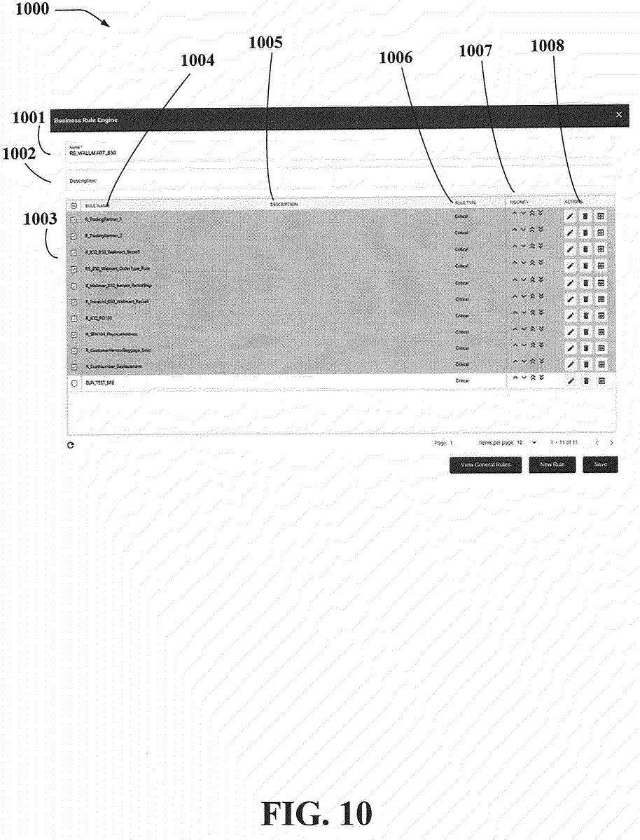

In an aspect, the GUI 700 may include a MapAndBRE (Mapping) graphical interface object 706. The Mapping graphical interface object 708 may allow users to select options from a Mapping menu (illustrated in FIG. 10) for business rules for a specific electronic business data format, supplier/partner information and other rules associated with mapping one or more heterogeneous data sets to a one or more standardized business data sets.

In an aspect, the GUI 700 may include an XML Splitting graphical interface object 710 that allows a user to select options related to splitting electronic business data files based on XML tags for efficient processing.

In an aspect, the GUI 700 may include a Conversion graphical interface object 712. The Conversion graphical interface object 712 may allow a user to select options for the conversion process flow to allow more efficient translation of inbound data and outbound data from one or more heterogeneous data sets to one or more standardized business data sets.

In an aspect, the GUI 700 may include an Import graphical interface object 714. The Import graphical interface object 714 allows the user to select options from an Import menu (illustrated in FIG. 11) for import properties and schedule and other Import options.

FIG. 8 illustrates an exemplary Load menu 800 accessed from the Load graphical interface object 702. The Load menu 800 may include menu selections (801-804) that allow a user to select parameters and options for the Load process of the MIDO. For example, a user may access an adaptor menu item 801, a connection menu item 802, a target directory menu item 803 or a mask menu item 804. Other menu items and selections may be available. The Load menu 800 may also include a Schedule menu item 805 to allow the user to select or input various parameters and settings for scheduling a Load process.

FIG. 9 illustrates an exemplary Validate menu 900 accessed from the Validate graphical interface object 704. The Validate menu 900 may include one or more menu selections (901-902) to select, for example, an adaptor item 901 (to select EDI as a valid data file format, for example) or thread number menu item 902 to allow a user to select a number of threads that a validation process may execute. In addition, a Schedule menu item 903 may allow a user to select scheduling options for the validation process step, such as when to run a validation process and how often, for example.

FIG. 10 illustrates an exemplary Mapping menu 1000 accessed from the Mapping graphical interface object 708 that allows a user to select and automate certain business rule mappings for the one or more heterogeneous data sets to the one or more standardized business data sets. The Mapping menu 1000 may include menu and options fields such as name field 1001, a description field 1002 and a business rule table input field 1003. In an aspect, the business rule table input field 1003 may include a rule name field 1004, a rule description field 1005, a rule type field 1006, a rule priority field 1007 and an action field 1008. It is to be understood that these menus and fields 1001-1008 are exemplary and may have different forms and categories, along with associated options for a user to select via the GUI 700 and graphic interface elements.

FIG. 11 illustrates an exemplary Import menu 1100 accessed from the Import graphical interface object 714 that allows a user to select and automate certain import and schedule properties for the Import set jobs implemented by the MIDO 302 of the disclosed automatic business data interchange system. For example, the Import menu 1100 may include menu fields such as an adaptor menu item 1101, an SFTP connection menu item 1102, a file name menu item 1103, an encoding type menu item 1104 and an SFTP directory menu item 1105. In an aspect, a schedule menu item 1106 may also be available to allow a user to schedule certain import tasks and processes accordingly.

The disclosed automated electronic business data exchange may have the following advantages over existing systems:
1) The system’s disclosed logic defines and implements discrete processing steps for electronic document interchange processing flows (e.g., the system’s JSON, or other proprietary format for processing steps; for system execution)
2) asynchronous, distributed processing of the flows in an analogous performance-oriented software system (environment);
3) the system’s dynamic allocation & scaling of elastic compute resources for document processing flows based on artificial intelligence/situational intelligence (trend data of processing steps, data volumes, current response times + cost);
4) the system’s adaptive healing of app-resources (health, performance, reliability) across cloud regions;
5) a standardized universal process flow representation allowing for a single way to view/modify and reprocess the document; and
6) a graphical user interface for a display screen of a document processing flow designer for integrators.

Blocks of the flowcharts 400-600 support combinations of means for performing the specified functions and combinations of operations for performing the specified functions. It will also be understood that one or more blocks of the flowcharts 400-600, and combinations of blocks in the flowcharts 400-600, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present disclosure and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for automated electronic business data processing, comprising:
computer executable instructions to retrieve one or more heterogeneous business data files from an input business data source for ingestion into an electronic business load engine;
computer executable instructions to translate the one or more heterogeneous data files into one or more standardized business data files;
computer executable instructions to process the one or more standardized business data files for validation;
computer executable instructions to process, after the validation of the one or more standardized business data files, the one or more standardized business data files for output to a business data consumer destination; and
computer executable instructions to connect to one or more destination business systems within an organization to store the one or more standardized business data files.

2. The system of claim 1, where the computer executable instructions to translate the one or more heterogeneous data files into one or more standardized business data files comprise computer executable instructions to process the one or more heterogeneous data files in a three-step process flow.

3. The system of claim 2, where the computer executable instructions to process the one or more heterogeneous data files in a three-step process flow comprise computer executable instructions to process the one or more heterogeneous data files in an inbound process flow comprising a load step, a translate step and an import step.

4. The system of claim 2, where the computer executable instructions to process the one or more heterogeneous data files in a three-step process flow comprise computer executable instructions to process the one or more heterogeneous data files in an outbound process flow comprising an export step, a translate step and a transmit step.

5. The system of claim 1, where the computer executable instructions to translate the one or more heterogeneous data files into one or more standardized business data files comprise computer executable instructions to process the one or more heterogeneous data files in one or more cloud regions in communication with the system.

6. The system of claim 6, further comprising selecting the one or more cloud regions based on heuristic information about at least one of a health of one of the one or more cloud regions and an availability of the one of the one or more cloud regions.

7. A Multi-role Intelligent Dynamic Orchestrator (MIDO) for distributed synchronous and asynchronous processing of one or more heterogeneous data file, the MIDO comprising:
a UDPDL database configured to store process flow definitions and/or process flow rules for distributed synchronous and asynchronous processing of the one or more heterogeneous data files;
a process clock configured to list overdue jobs in the UDPDL database and coordinate the distributed synchronous and asynchronous processing of the one or more heterogeneous data files;
a cloud processor configured to determine a step in a process flow in the distributed synchronous and asynchronous processing of the one or more heterogeneous data files and determine a job in a cloud process available in one or more cloud regions in communication with the MIDO to execute the determined step; and
a job execution engine configured to select an instance of a job step function from a library of execution functions and select a physical cloud node from the one or more cloud regions for execution of the determined job in the cloud process.

8. The MIDO of claim 7, where the job execution engine selects the instance of the job step function based on at least one of a maximum number of threads of the instance of the job step function and a run time for threads of the instance of the job step function.

9. The MIDO of claim 7, where the job execution engine selects the physical cloud node from the one or more cloud regions based on at least one of an availability of one of the one or more cloud regions and a health indicator of the one of the one or more cloud regions.

10. The MIDO of claim 7, where the UDPDL database comprises computer executable instructions to process the one or more heterogeneous data files in an inbound process flow comprising a load step, a translate step and an import step.

11. The MIDO of claim 7, where the UDPDL database comprises computer executable instructions to process the one or more heterogeneous data files in an outbound process flow comprising an export step, a translate step and a transmit step.

12. The MIDO of claim 7, where the MIDO is configured to provide dynamic allocation and scaling of elastic cloud computing resources for document processing flows based on situational intelligence.

13. The MIDO of claim 7, where the MIDO is configured to provide adaptive healing of computing resources across the one or more cloud regions.

14. The MIDO of claim 7, where the UDPDL database comprises software instructions for process flow definition for the MIDO in an extensible form.

15. The MIDO of claim 7, where the UDPDL database comprises sequencing/scheduling computer executable instructions for independent process steps for an inbound process flow and an outbound process flow in a three-step process.

16. The MIDO of claim 7, where the UDPDL database comprises computer executable instructions to allows selection and scheduling of different process flows independent of the one or more cloud regions.

17. A GUI interface for generating Universal Electronic Document Processing language (UDPDL) process flows for conversion of electronic business data, the GUI comprising:
a load graphical interface object configured to allow a user to select load process and settings for the UDPDL process flows;
a validate graphical interface object configured to allow a user to select validation process and settings for the UDPDL process flows;
a mapping graphical interface object configured to allow a user to select mapping and business rule process settings for the UDPDL process flows; and
an import graphical interface object configured to allow a user to select import process settings for the UDPDL process flows.

18. The GUI of claim 17, further comprising at least one of:
a packing graphical interface object configured to a user to specify conversion of the electronic business data into a different file format and/or prepare the electronic business data for subsequent processing;
an XML splitting graphical interface object configured to allow a user to select options related to splitting electronic business data files based on XML tags; and
a conversion graphical interface object configured to allow a user to select options for translation of inbound data conversion and outbound data conversion from one or more heterogeneous data sets to one or more standardized business data sets.

19. The GUI of claim 17, where at least one of the load graphical interface object, the validate graphical interface object and the mapping graphical interface object are configured to provide one or more data input fields and/or one or more data input menus.

20. The GUI of claim 19, where the one or more data input fields and/or the one or more data input menus comprise a schedule input.
